(19) United States
(12) Patent Application Publication
(10) Pub. No.: US 2004/0227411 A1
(43) Pub. Date: Nov. 18, 2004

(54) Method for manufacturing teeth of linear step motors

(76) Inventors: Shuen-Shing Hsiao, Taichung (TW); Chih-Sung Tsai, Taichung (TW)

Correspondence Address: CHARLES E. BAXLEY, ESQUIRE, Fifth Floor, 59 John Street, New York, NY, 10038, US

(21) Appl. No.: 10/439,687

(22) Filed: May 16, 2003

(51) Int. Cl. H02K 41/00

(52) U.S. Cl. 310/12

(57) ABSTRACT

This invention relates to a method for manufacturing teeth of a stator or rotor of a linear step motor. In order to let linear step motor move in small distance, either the stator or rotor need to be carved into miniscule indent and protruded teeth type. Traditional cutting and itching carving has the disadvantage of high cost. Therefore, this invention using sand spray manufacturing process to produce teeth type of motor stator has the advantages of easy manufacturing, flexibly changing teeth type, incurring no pollution of itching carving process. Therefore, this invention has not only high efficiency but also environmental friendliness.

### FIELD OF THE INVENTION

The present invention relates to a method for making teeth of rotor or stator of linear stepping motors. The teeth are made by way of sand spray manufacturing process to produce teeth of motor stator has the advantages of easy manufacturing, flexibly changing teeth type, incurring no pollution of itching carving process.

### BACKGROUND OF THE INVENTION

Linear step motors are used in a wide range of industry such as the picking machine for transferring chips or high speed chip examining machine. The linear stepping motors are functioned by the magnetic mutual affection between the stator and the rotor. In order to provide delicate feeding, tiny grooves are carved in the stator or the rotor so as to make teeth at the abutment portion between the stator and the rotor. FIG. 6 shows a conventional linear stepping motor and includes a core 82 and a coil 81 wrapped around the core 82. Teeth 821 are defined in the core 82 and a stator 83 is located beneath the core 82. The stator 83 has teeth 831 which are engaged with the teeth 821 of the core 82. The core 82 and the coil 81 are moved relative to the stator 83 so that they are called stator in a motor. The shape of the teeth 821 and 831 is rectangular so that even only a tiny gap is moved between the stator and the rotor, a huge change is resulted in the magnetic lines and the change of the motor becomes too much severe.

Generally, the way of the method for making teeth of the linear step motor is itching carving or milling. Either of the two methods has inherent shortcomings. For the milling, the milling tool has to be made to be able to make delicate teeth so that the tool is expensive. The gaps between teeth are so tiny so that it takes a lot of manufacturing time. Besides, the milling tool can only be move in linear direction so that it is difficult to make special shape of teeth. Because of the wearing on the milling tool, it is hard to maintain a desired precision of the teeth.

For the itching carving, it involves too many steps and has a high manufacturing cost. Besides, the chemical used in the itching process includes pollutants.

The present invention intends to provide a method for making the teeth in a linear step motor and the method is less expensive and environmentally friendly.

### SUMMARY OF THE INVENTION

In accordance with one aspect of the present invention, there is provided a method for manufacturing teeth of linear step motors and the method is sand spray. The particles of hard material such as aluminum oxide or silicon carbide, hit the surface of the stator or rotator at high speed so as to form the desired shape of teeth. The method does not involve pollutants as involved in the itching carving and the area of the stator or rotor that is not to be hit by the particles is masked by a mask so that the mask can be made to produce plural layers of teeth for the rotor or stator. The directions that the particles are sent or the molds from which the particles eject can be adjusted, and the times of spray can also be increased so as to obtain smooth teeth and to reduce the change of the speed of the linear step motor.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the method for manufacturing teeth of linear step motors of the present invention;

FIG. 2 shows the linear step motor which is made by the method of the present invention;

FIG. 3 shows one of the processes of the method the method of the present invention;

FIG. 4 shows another one of the processes of the method the method of the present invention;

FIG. 5 shows a chart of the comparison of cogging forces of different linear step motors, and

FIG. 6 shows a conventional linear step motor.

### DETAILED DESCRIPTION OF THE PREFERRED EMBODIMENT

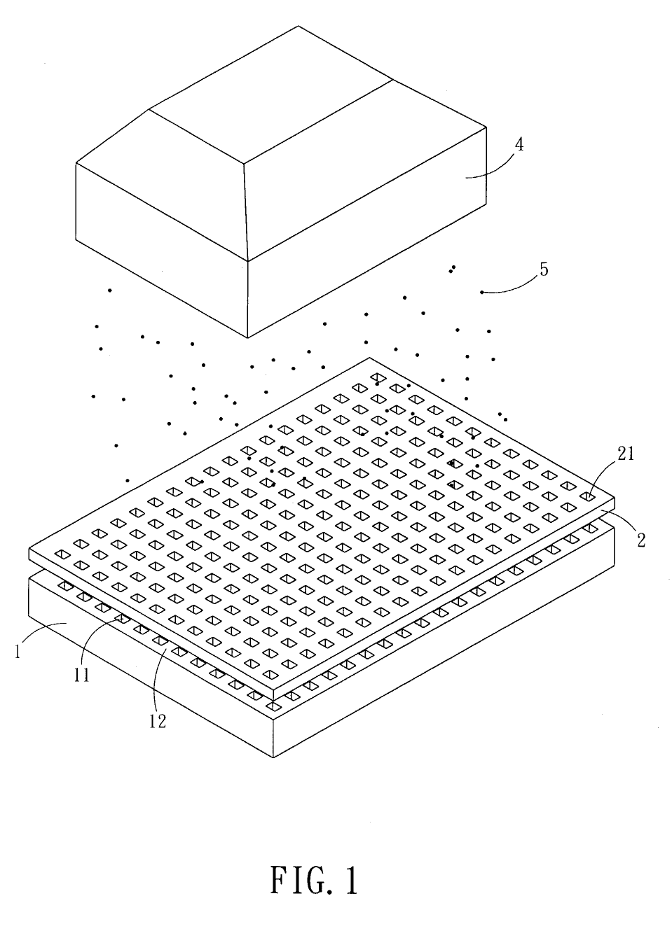

FIG. 1 shows the method for manufacturing teeth of linear step motors. A mask 2 is placed above an object 1 to be manufactured and apertures 21 are defined through the mask 2 so that particles 5 pass through the apertures 21. A pressurizing machine 4 provides energy for the particles 5 so that the particles 5 hit the surface of the object 1. Only the area which is not covered by the mask 2 is hit by the particles 5 passing through the apertures 21. The particles 5 make recesses 11 on the surface of the object 1 so that the area that is not covered forms the desired shape of teeth. The method is convenient to proceed and will not pollute the environment.

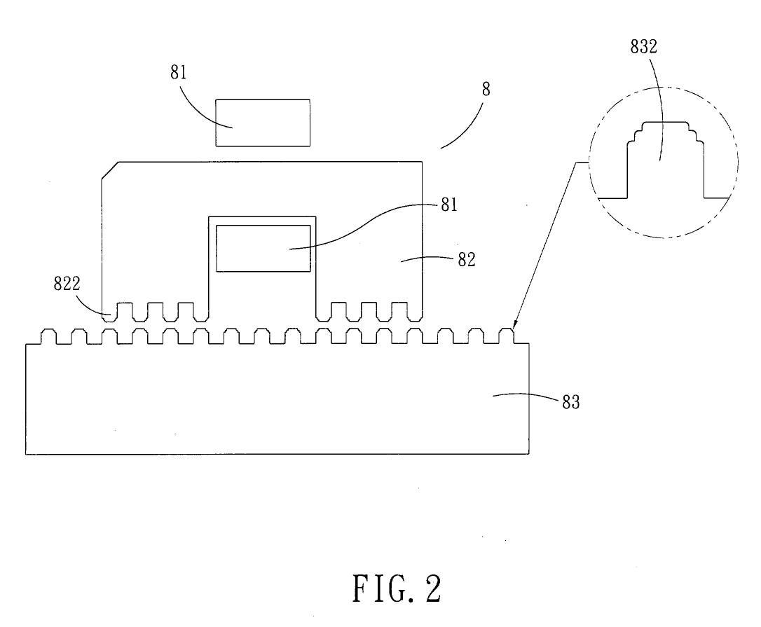

FIG. 2 shows the linear step motor made by the method of the present invention, the linear step motor 8 includes a core 82 and a coil 81 which is wrapped around the core 82. Teeth 822 are defined in the core 82 and a stator 83 is located beneath the core 82. The stator 83 has teeth 832 which are engaged with the teeth 822 of the core 82. The teeth 832 and 822 can be made by multiple times of spreading of particles 5 so that the teeth 832 can be made to be stepped teeth which improve the severe change of speed of the linear step motor.

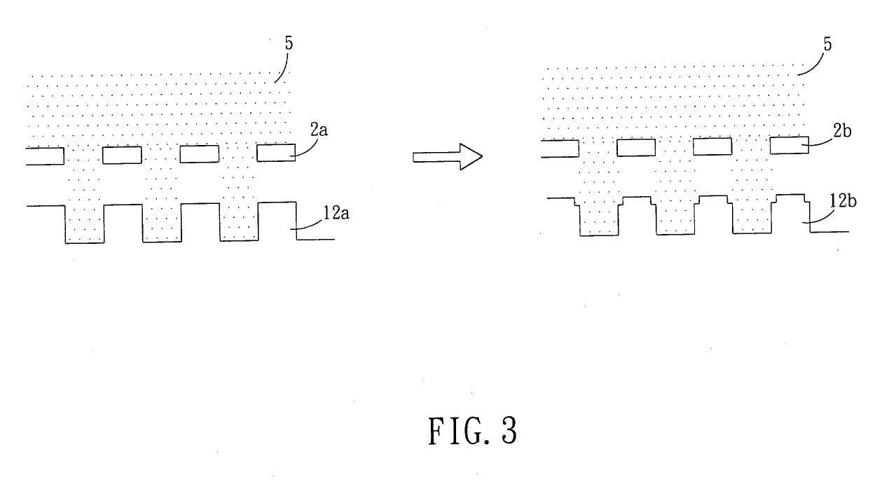

FIG. 3 shows the method for manufacturing the teeth 832 as shown in FIG. 2, wherein the mask 2a and 2b are respectively placed above the object. On the left side of FIG. 3 shows the high speed particles 5 travel downward so as to form desired shape of teeth 12a. On the right side of FIG. 3 shows that the teeth 12a is covered by the mask 2b and the particles 5 hit the object so as to form stepped teeth 12b.

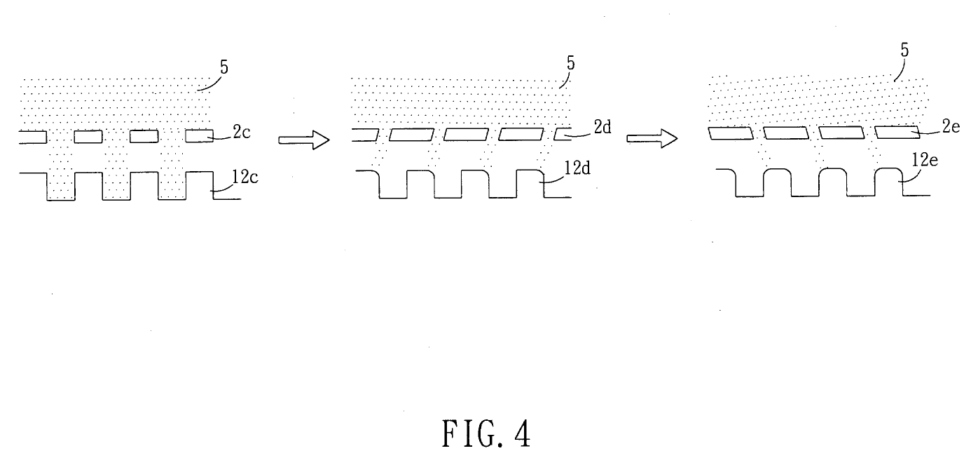

As shown in FIG. 4, masks 2c, 2d and 2e are respectively placed above the object. The left of FIG. 4 shows that the mask 2c covers the object and particles 5 hit downward the object so as to from teeth 12c. The middle and the right of FIG. 4 show the apertures of the masks 2d and 2e has inclined inner periphery so that when the particles 5 pass through the apertures, the teeth 12c are formed to be teeth 12d and 12e having rounded teeth.

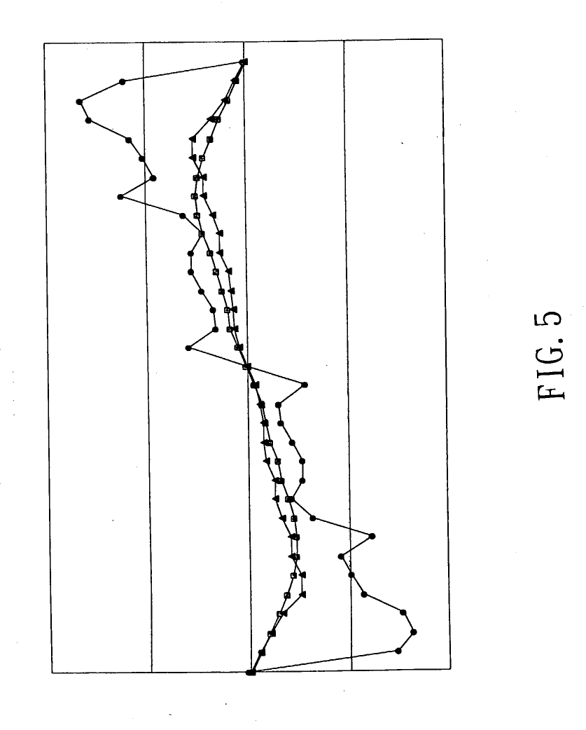

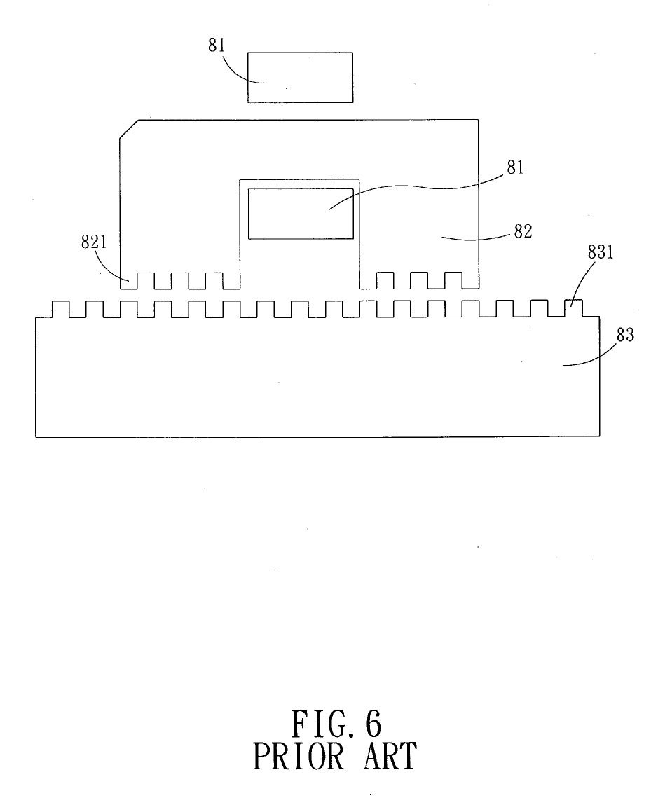

FIG. 5 shows the cogging forces between three different linear stepping motors. One of the three linear stepping motors is a conventional linear step motor which has the teeth as shown in FIG. 6 made by milling and is represented by circles in FIG. 5. The other two linear stepping motors in FIG. 5 are stepped teeth as shown in FIG. 3 and represented by rectangles, and rounded teeth as shown in FIG. 4 and represented by triangles. A width of each tooth of a linear step motor is separated into 30 sections which are calculated the magnetic force by magnetic analysis software. The result shows that the change of the magnetic force of the linear step motors having stepped teeth and rounded teeth is less than the linear step motor having teeth made by conventional method. Accordingly, the speed change can be improved.

The method of the present invention has better efficient and is friendly to the environment. The manufacturing cost is lower than conventional methods. The rounded and stepped teeth improve the change of speed of the linear step motors.

While we have shown and described the embodiment in accordance with the present invention, it should be clear to those skilled in the art that further embodiments may be made without departing from the scope of the present invention.

What is claimed is:

1. A method for manufacturing teeth of linear step motors, comprising:
a step of placing a mask above an object, the mask having apertures, the object being made of magnetic conductive material for stator or rotator of linear step motors, and
a step of hitting the object at high speed via the apertures by the particles so as to from teeth on the object.

2. The method as claimed in claim 1, wherein the mask is changed to have different shapes of apertures and the object is hit by the particles so form stepped teeth.

3. The method as claimed in claim 1, wherein the particles hit the object at an angle so as to form rounded teeth.

4. A linear step motor, wherein teeth of a stator or a rotator of the linear step motor are made by the method as defined in claim 1, 2 or 3.
